(19) United States
(12) Patent Application Publication
(10) Pub. No.: US 2025/0338896 A1
(43) Pub. Date: Nov. 6, 2025

(54) AEROSOL-GENERATING DEVICE WITH USER AUTHENTICATION

(71) Applicant: Philip Morris Products S.A., Neuchatel (CH)

(72) Inventors: Rui Nuno Rodrigues Alves BATISTA, Morges (CH); Alexandra SEREDA, Zurich (CH)

(73) Assignee: Philip Morris Products S.A., Neuchatel (CH)

(21) Appl. No.: 18/855,546

(22) PCT Filed: May 10, 2023
(86) PCT No.: PCT/EP2023/062385

§ 371 Date: Oct. 9, 2024

(30) Foreign Application Priority Data
May 10, 2022 (EP) 22172585.6

(51) Int. Cl. A24F 40/49; A24F 40/51; A24F 40/53; A24F 40/60; G06F 21/32

(52) U.S. Cl. CPC A24F 40/49; A24F 40/51; A24F 40/60; G06F 21/32; A24F 40/53

(57) ABSTRACT

An aerosol-generating device, including: an emitter configured to emit electromagnetic radiation of at least two distinct frequencies, one of the at least two distinct frequencies being within the infrared spectrum and another one of the at least two distinct frequencies being within the visible light spectrum; a detector configured to receive electromagnetic radiation at least in the spectrum of the at least two distinct frequencies emitted by the emitter; and a controller configured to perform facial recognition of a user of the aerosol-generating device for user authentication based upon detector output. A method for performing user authentication in the aerosol-generating device is also provided.

The present invention relates to an aerosol-generating device. The invention further relates to a method for performing user authentication in an aerosol-generating device.

It is known to provide an aerosol-generating device for generating an inhalable vapor. Such devices may heat aerosol-forming substrate to a temperature at which one or more components of the aerosol-forming substrate are volatilised without burning the aerosol-forming substrate. Aerosol-forming substrate may be provided as part of an aerosol-generating article. The aerosol-generating article may have a rod shape for insertion of the aerosol-generating article into a cavity, such as a heating chamber, of the aerosol-generating device. A heating element may be arranged in or around the heating chamber for heating the aerosol-forming substrate once the aerosol-generating article is inserted into the heating chamber of the aerosol-generating device.

It would be desirable to have an aerosol-generating device enabling user authentication. It would be desirable to have an aerosol-generating device with improved user authentication. It would be desirable to have an aerosol-generating device enabling user age verification. It would be desirable to have an aerosol-generating device enabling improved user age verification.

According to an embodiment of the invention there is provided an aerosol-generating device that may comprise an emitter. The emitter may be configured to emit electromagnetic radiation of at least two distinct frequencies. One of the frequencies may be within the infrared spectrum. The aerosol-generating device may further comprise a detector. The detector may be configured to receive electromagnetic radiation at least in the spectrum of the two distinct frequencies emitted by the emitter. The aerosol-generating device may further comprise a controller. The controller may be configured to perform facial recognition of a user of the aerosol-generating device for user authentication based upon the detector output.

The invention relates to an aerosol-generating device comprising an emitter. The emitter is configured to emit electromagnetic radiation of at least two distinct frequencies. One of the frequencies is within the infrared spectrum. The aerosol-generating device further comprises a detector. The detector is configured to receive electromagnetic radiation at least in the spectrum of the two distinct frequencies emitted by the emitter. The aerosol-generating device further comprises a controller. The controller is configured to perform facial recognition of a user of the aerosol-generating device for user authentication based upon the detector output.

The user authentication enhances safety of the device. Exemplarily, an underaged user may not be able to use the device accidentally. As a further example, an unauthorized user may be prevented from using the device after loss of the device.

Emitting electromagnetic radiation of at least two distinct wavelengths may improve the user authentication process. For example, different ambient light conditions may be problematic if only visible light is used for the user authentication. By using electromagnetic radiation in the infrared spectrum, user authentication may be improved in low light conditions.

The controller may be configured to further perform age verification of a user of the aerosol-generating device based upon the detector output.

Age verification may improve the functionality of the device to prevent an underaged user from using the device.

The emitter may be configured to emit electromagnetic radiation within the visible light spectrum. This enables age verification at both night and daylight conditions with high accuracy. Electromagnetic radiation within the infrared spectrum may be optimal in low light conditions such as at night. Electromagnetic radiation within the visible light spectrum may be optimal in bright conditions such as during the day.

Configuring the emitter to emit electromagnetic radiation within the visible light spectrum may enable that the emitter has a user interface function. The user interface function may exemplarily allow to communicate a status to the user. This may be facilitated with a variation of the visible light such as a blinking, a variation in brightness or a variation of color of the light. This may be utilized to visually communicate a status of a user authentication to a user.

The emitter may comprise an LED. The emitter may comprise an OLED. The emitter may comprise a laser.

The emitter may be embedded in a housing of the aerosol-generating device. The emitter may be arranged behind a transparent portion of the housing. The emitter may be hermetically sealed behind the transparent portion of the housing. The transparent portion of the housing may be arranged at a proximal end of the housing. Due to this arrangement, the emitter may be protected from outside influences.

The transparent portion may act as a diffuser element for the electromagnetic radiation emitted by the emitter.

The emitter may be overmolded with a polymeric compound to embed the emitter in the housing of the aerosol-generating device. The polymeric compound may be transparent to act as the transparent portion of the housing.

The emitter may be arranged such that the electromagnetic radiation emitted by the emitter is reflected by the housing of the aerosol-generating device towards a proximal direction. Due to this arrangement, the electromagnetic radiation from the emitter may be spread more uniformly or concentrated within a predetermined range.

The LED may be used to emit the electromagnetic radiation towards a face of a user. The face of a user may be illuminated by the electromagnetic radiation of the LED. This illumination may be utilized in that that detector may capture image data of the user's face. The detector may then output information comprising image data information of the user's face.

The emitter may comprise at least two LEDs.

Two LEDs may enable to emit the two distinct wavelengths of the electromagnetic radiation.

The emitter may comprise at least one LED capable of emitting electromagnetic radiation in the visible spectrum.

This electromagnetic radiation may be optimally suited to enable user authentication during bright ambient light conditions, for example in daylight or well illuminated spaces.

The emitter may comprise at least one LED capable of emitting electromagnetic radiation in the infrared spectrum.

This electromagnetic radiation may be optimally suited to enable user authentication during low light conditions, for example during night or in poorly illuminated spaces.

The combination of at least one LED capable of emitting electromagnetic radiation in the visible spectrum and at least one LED capable of emitting electromagnetic radiation in the infrared spectrum may enable the device to perform user authentication in all light conditions. Particularly, improved user authentication may be possible during daylight conditions as well as in low light environments.

The emitter may comprise at least one LED capable of emitting electromagnetic radiation with a wavelength of between 700 nm and 1400 nm, preferably between 800 nm and 1200 nm, more preferably between 820 nm and 890 nm, most preferably of 850 nm.

This infrared spectrum bordering the visible spectrum may be particularly suitable to improve user authentication in typical low light conditions.

The emitter may comprise at least two LEDs, a first LED capable of emitting electromagnetic radiation in the visible spectrum, and a second LED capable of emitting electromagnetic radiation in the infrared spectrum.

The emitter may comprise an LED ring.

An LED ring may emit electromagnetic radiation uniformly. Alternatively or additionally, a diffuser element may be arranged in front of the emitter. A uniform distribution of the emitted electromagnetic radiation may be beneficial to uniformly illuminate a user's face. A uniform illumination of a user's face may improve the quality of the image data received by the detector and may thus in turn improve the quality of the user authentication performed by the controller.

The emitter may be arranged at a proximal end of the device.

The user authentication may be performed by a user pointing the proximal end of the device towards her/his face. The emitter may then illuminate the user's face as described herein.

The emitter may be arranged surrounding a proximal opening of the device.

The surrounding configuration may be enabled by providing the emitter as a ring- shaped emitter. Exemplarily, as described herein, the emitter may be configured as an LED ring.

The proximal opening may be configured as an opening of a cavity of the device configured to receive an aerosol-generating article as described in more detail below. A surrounding configuration may enable to perform the user authentication independent of an aerosol-generating article being received in the cavity of the device or not. In both cases, the emitter will be able to emit the electromagnetic radiation in a direction proximal of the device.

The emitter may be arranged to emit the electromagnetic radiation in a proximal direction.

The face of a user may be proximal of the device during the user authentication process.

The detector may be configured as a camera.

The camera may be configured to detect the at least two distinct wavelengths emitted by the emitter. Exemplarily, the face of a user illuminated by the emitter may reflect the electromagnetic radiation of the emitter back to the camera so that the camera may receive image data of the user's face.

The camera may be a CCD camera or may comprise a CMOS sensor.

The detector may be arranged at a proximal end of the device.

The detector may be arranged at the same end of the device at which the emitter is arranged. The detector may be arranged near to the emitter. The detector may be arranged adjacent the emitter. The detector may be arranged abutting the emitter. If the aerosol- generating device comprises a cavity and a respective opening as described herein, the detector may be arranged on the ring-shaped emitter, preferably on a peripheral and proximal point of the ring-shaped emitter.

The detector may comprise a focal length of between 10 cm and 30 cm, preferably between 15 cm and 25 cm, more preferably between 18 cm and 22 cm.

This focal length may be chosen to obtain improved image data of a user's face. This focal length may be particularly optimized to improve the age verification process of a user's face. The age verification process of a user's face may be improved by a specific focal length as this may enable accurate measurement of a user's face.

The age verification process may utilize information of a user's face such as face proportion information of a user's face. The face proportion information may comprise a size or a proportion of a user's face in comparison with preset face information. The preset face information may comprise face size distributions of age groups such as adults, teenagers and children. The preset face information may comprise face proportion distributions of age groups such as adults, teenagers and children.

The preset face information may particularly comprise one or both of axial eye length distributions and central region human length distributions of age groups such as adults, teenagers and children.

One or both of the axial eye length and the central region human length may be determined by the controller on basis of the image data captured by the detector. The accuracy of this determination may be improved when the user's image data is taken at a focal length as described herein.

The preset axial eye length distributions may comprise values of 21 millimeter to 24 millimeter for adults, 19 millimeter to 20 millimeter for teenagers and 16 millimeter to 18 millimeter for children.

If the axial eye length of a user is determined by the controller to be below 18 millimeter, preferably below 20 millimeter, the controller may prevent the aerosol-generating device from being operated.

Prevention of operation of the aerosol-generating device may be understood such that no aerosol can be generated. Other functions of the aerosol-generating device such as the user authentication and the age verification may still be active.

The preset central region human length distributions may comprise values of 3 millimeter to 7 millimeter for adults, 2 millimeter to 5 millimeter for teenagers and 2 millimeter to 5 millimeter for children. A trained detection algorithm may be provided for the age verification process. The detection algorithm may use data from a predetermined database. Similar to the axial eye length distributions, the aerosol-generating device may be prevented from being operated if a teenager or child is identified in the age verification process.

The controller of the aerosol-generating device may use an algorithm as described in “Diagnostic Features for Human Categorization of Adult and Child Faces” (Faghel-Soubeyrand S, Kloess JA, Gosselin F, Charest I and Woodhams J (2021) Diagnostic Features for Human Categorisation of Adult and Child Faces. Front. Psychol. 12:775338. doi:10.3389/fpsyg.2021.775338) to analyze the image data of the detector, particularly to analyze the image data of the detector for the age verification process.

The controller may be configured to control the emitter to emit different colours in the visible spectrum to indicate to a user if the user may be within the correct focal length of the detector or not.

For example, the controller may control the emitter to emit a specific colour when the user's face is in the correct focal length of the detector. Alternatively or additionally, a blinking light signal or other optical signal may be emitted by the emitter indicative of a correct focal length between the detector and a user's face. A user being in the correct focal length of the detector may be determined by the controller based upon the image data of the detector by any known means.

For determining whether a user's face is in the correct focal length of the detector, the aerosol-generating device may comprise a distance measurement sensor. The distance measurement sensor may comprise an autofocus function. The distance measurement sensor may comprise a time-of-flight sensor. The distance measurement sensor may be part of the detector. Both the distance measurement of the user's face as well as the detection of the electromagnetic radiation emitted by the emitter may be facilitated by the detector. Alternatively, the detector may comprise a fixed focal length lens or may be configured as a fixed focal length camera.

The controller may be configured to prevent aerosol generation of the device, when the facial recognition may be negative.

The controller may be configured to enable aerosol generation of the device, when the facial recognition may be positive.

The controller may comprise a lookup table comprising face proportion information indicative of the age of the user. The controller may be configured to perform age verification by comparing the output of the detector with the information of the lookup table.

The face proportion information stored in the lookup table may also be referred to as preset face information as described herein. The output of the detector may also be referred to as image data of the detector as described herein.

The device may further comprise a user authentication button. The user authentication button may be configured to start the user authentication process when pressed.

The authentication button may be arranged on the outer periphery of the aerosol- generating device.

Pressing of the authentication button may lead to the emitter emitting electromagnetic radiation as described herein.

Exemplarily, pressing of the authentication button may lead to the emitter emitting electromagnetic radiation of a first colour in the visible spectrum. I user is thus informed that the authentication is initiated. The user may then place his/her face proximal to the detector within the correct focal length of the detector as described herein. The correct placement of the user's face proximal of the detector and within the correct focal length of the detector may then be indicated by one or both of a second colour in the visible spectrum distinct from the first colour or a blinking light. Further visual guidance may be provided by the emitter in the authentication process. Exemplarily, a third distinct colour in the visible spectrum may be emitted by the emitter to indicate the ongoing user authentication. This may be useful for a user to indicate that the user's face should not be moved relative to the detector. A fourth distinct colour in the visible spectrum may be emitted by the emitter after completion of the user authentication. The fourth distinct colour may be provided with two distinct colours depending upon whether the user authentication was positive and the device can be used or whether the user authentication was negative and the use of the aerosol-generating device is prevented. All the colours described herein may be different from each other such that a user can easily differentiate between the different stages of the authentication process. Alternatively, other visual clues such blinking lights may be utilized by the emitter for the same purpose.

The device may comprise a user database. The controller may be configured to compare the output of the detector with the user data of the user database for the user authentication.

The user database may comprise user information for which use of the aerosol-generating device is permitted. The image data of the detector may be compared, by the controller, with the user information of the user database to perform a check whether the detected user is allowed to use the device.

As used herein, the term ‘proximal’ is used to describe the relative positions of components, or portions of components, of the aerosol-generating device in relation to the direction in which a user draws on the aerosol-generating device during use thereof.

The aerosol-generating device may comprise a mouth end through which in use an aerosol exits the aerosol-generating device and is delivered to a user. The mouth end may also be referred to as the proximal end. In use, a user draws on the proximal or mouth end of the aerosol-generating device in order to inhale an aerosol generated by the aerosol-generating device. The aerosol-generating device comprises a distal end opposed to the proximal or mouth end. The proximal or mouth end of the aerosol-generating device may also be referred to as the downstream end and the distal end of the aerosol-generating device may also be referred to as the upstream end. Components, or portions of components, of the aerosol-generating device may be described as being upstream or downstream of one another based on their relative positions between the proximal, downstream or mouth end and the distal or upstream end of the aerosol-generating device.

As used herein, an ‘aerosol-generating device’ relates to a device that interacts with an aerosol-forming substrate to generate an aerosol. The aerosol-forming substrate may be part of an aerosol-generating article, for example part of a smoking article. An aerosol-generating device may be a smoking device that interacts with an aerosol-forming substrate of an aerosol- generating article to generate an aerosol that is directly inhalable into a user's lungs thorough the user's mouth. An aerosol-generating device may be a holder. The device may be an electrically heated smoking device. The aerosol-generating device may comprise a housing, electric circuitry, a power supply, a heating chamber and a heating element.

As used herein with reference to the present invention, the term ‘smoking’ with reference to a device, article, system, substrate, or otherwise does not refer to conventional smoking in which an aerosol-forming substrate is fully or at least partially combusted. The aerosol-generating device of the present invention is arranged to heat the aerosol-forming substrate to a temperature below a combustion temperature of the aerosol-forming substrate, but at or above a temperature at which one or more volatile compounds of the aerosol-forming substrate are released to form an inhalable aerosol.

The aerosol-generating device may comprise electric circuitry. The electric circuitry may comprise a microprocessor, which may be a programmable microprocessor. The microprocessor may be part of a controller. The electric circuitry may comprise further electronic components. The electric circuitry may be configured to regulate a supply of power to the heating element. Power may be supplied to the heating element continuously following activation of the aerosol-generating device or may be supplied intermittently, such as on a puff-by-puff basis. The power may be supplied to the heating element in the form of pulses of electrical current. The electric circuitry may be configured to monitor the electrical resistance of the heating element, and preferably to control the supply of power to the heating element dependent on the electrical resistance of the heating element.

The aerosol-generating device may comprise a power supply, typically a battery, within a main body of the aerosol-generating device. In one embodiment, the power supply is a Lithium-ion battery. Alternatively, the power supply may be a Nickel-metal hydride battery, a Nickel cadmium battery, or a Lithium based battery, for example a Lithium-Cobalt, a Lithium-Iron-Phosphate, Lithium Titanate or a Lithium-Polymer battery. As an alternative, the power supply may be another form of charge storage device such as a capacitor. The power supply may require recharging and may have a capacity that enables to store enough energy for one or more usage experiences; for example, the power supply may have sufficient capacity to continuously generate aerosol for a period of around six minutes or for a period of a multiple of six minutes. In another example, the power supply may have sufficient capacity to provide a predetermined number of puffs or discrete activations of the heating element.

The cavity of the aerosol-generating device may have an open end into which the aerosol-generating article is inserted. The open end may be a proximal end. The cavity may have a closed end opposite the open end. The closed end may be the base of the cavity. The closed end may be closed except for the provision of air apertures arranged in the base. The base of the cavity may be flat. The base of the cavity may be circular. The base of the cavity may be arranged upstream of the cavity. The open end may be arranged downstream of the cavity. The cavity may have an elongate extension. The cavity may have a longitudinal central axis. A longitudinal direction may be the direction extending between the open and closed ends along the longitudinal central axis. The longitudinal central axis of the cavity may be parallel to the longitudinal axis of the aerosol-generating device.

The cavity may be configured as a heating chamber. The cavity may have a cylindrical shape. The cavity may have a hollow cylindrical shape. The cavity may have a shape corresponding to the shape of the aerosol-generating article to be received in the cavity. The cavity may have a circular cross-section. The cavity may have an elliptical or rectangular cross- section. The cavity may have an inner diameter corresponding to the outer diameter of the aerosol-generating article.

An airflow channel may run through the cavity. Ambient air may be drawn into the aerosol-generating device, into the cavity and towards the user through the airflow channel. Downstream of the cavity, a mouthpiece may be arranged or a user may directly draw on the aerosol-generating article. The airflow channel may extend through the mouthpiece.

In any of the aspects of the disclosure, the heating element may comprise an electrically resistive material. Suitable electrically resistive materials include but are not limited to: semiconductors such as doped ceramics, electrically “conductive” ceramics (such as, for example, molybdenum disilicide), carbon, graphite, metals, metal alloys and composite materials made of a ceramic material and a metallic material. Such composite materials may comprise doped or undoped ceramics. Examples of suitable doped ceramics include doped silicon carbides. Examples of suitable metals include titanium, zirconium, tantalum platinum, gold and silver. Examples of suitable metal alloys include stainless steel, nickel- , cobalt- , chromium- , aluminium- titanium- zirconium- , hafnium- , niobium- , molybdenum- , tantalum- , tungsten- , tin- , gallium- , manganese- , gold-and iron-containing alloys, and super-alloys based on nickel, iron, cobalt, stainless steel, Timetal® and iron-manganese-aluminium based alloys. In composite materials, the electrically resistive material may optionally be embedded in, encapsulated or coated with an insulating material or vice-versa, depending on the kinetics of energy transfer and the external physicochemical properties required.

As described, in any of the aspects of the disclosure, the heating element may be part of an aerosol-generating device. The aerosol-generating device may comprise an internal heating element or an external heating element, or both internal and external heating elements, where “internal” and “external” refer to the aerosol-forming substrate. An internal heating element may take any suitable form. For example, an internal heating element may take the form of a heating blade. Alternatively, the internal heater may take the form of a casing or substrate having different electro-conductive portions, or an electrically resistive metallic tube. Alternatively, the internal heating element may be one or more heating needles or rods that run through the center of the aerosol-forming substrate. Other alternatives include a heating wire or filament, for example a Ni-Cr (Nickel-Chromium), platinum, tungsten or alloy wire or a heating plate. Optionally, the internal heating element may be deposited in or on a rigid carrier material. In one such embodiment, the electrically resistive heating element may be formed using a metal having a defined relationship between temperature and resistivity. In such an exemplary device, the metal may be formed as a track on a suitable insulating material, such as ceramic material, and then sandwiched in another insulating material, such as a glass. Heaters formed in this manner may be used to both heat and monitor the temperature of the heating elements during operation.

An external heating element may take any suitable form. For example, an external heating element may take the form of one or more flexible heating foils on a dielectric substrate, such as polyimide. The flexible heating foils can be shaped to conform to the perimeter of the substrate receiving cavity. Alternatively, an external heating element may take the form of a metallic grid or grids, a flexible printed circuit board, a molded interconnect device (MID), ceramic heater, flexible carbon fibre heater or may be formed using a coating technique, such as plasma vapour deposition, on a suitable shaped substrate. An external heating element may also be formed using a metal having a defined relationship between temperature and resistivity. In such an exemplary device, the metal may be formed as a track between two layers of suitable insulating materials. An external heating element formed in this manner may be used to both heat and monitor the temperature of the external heating element during operation.

As an alternative to an electrically resistive heating element, the heating element may be configured as an induction heating element. The induction heating element may comprise an induction coil and a susceptor. In general, a susceptor is a material that is capable of generating heat, when penetrated by an alternating magnetic field. When located in an alternating magnetic field. If the susceptor is conductive, then typically eddy currents are induced by the alternating magnetic field. If the susceptor is magnetic, then typically another effect that contributes to the heating is commonly referred to hysteresis losses. Hysteresis losses occur mainly due to the movement of the magnetic domain blocks within the susceptor, because the magnetic orientation of these will align with the magnetic induction field, which alternates. Another effect contributing to the hysteresis loss is when the magnetic domains will grow or shrink within the susceptor. Commonly all these changes in the susceptor that happen on a nano-scale or below are referred to as “hysteresis losses”, because they produce heat in the susceptor. Hence, if the susceptor is both magnetic and electrically conductive, both hysteresis losses and the generation of eddy currents will contribute to the heating of the susceptor. If the susceptor is magnetic, but not conductive, then hysteresis losses will be the only means by which the susceptor will heat, when penetrated by an alternating magnetic field. According to the invention, the susceptor may be electrically conductive or magnetic or both electrically conductive and magnetic. An alternating magnetic field generated by one or several induction coils heat the susceptor, which then transfers the heat to the aerosol-forming substrate, such that an aerosol is formed. The heat transfer may be mainly by conduction of heat. Such a transfer of heat is best, if the susceptor is in close thermal contact with the aerosol-forming substrate.

As used herein, the term ‘aerosol-generating article’ refers to an article comprising an aerosol-forming substrate that is capable of releasing volatile compounds that can form an aerosol. For example, an aerosol-generating article may be a smoking article that generates an aerosol that is directly inhalable into a user's lungs through the user's mouth. An aerosol-generating article may be disposable.

As used herein, the term ‘aerosol-forming substrate’ relates to a substrate capable of releasing one or more volatile compounds that can form an aerosol. Such volatile compounds may be released by heating the aerosol-forming substrate. An aerosol-forming substrate may conveniently be part of an aerosol-generating article or smoking article.

The aerosol-forming substrate may be a solid aerosol-forming substrate. The aerosol-forming substrate may comprise both solid and liquid components. The aerosol-forming substrate may comprise a tobacco-containing material containing volatile tobacco flavour compounds which are released from the substrate upon heating. The aerosol-forming substrate may comprise a non-tobacco material. The aerosol-forming substrate may comprise an aerosol former that facilitates the formation of a dense and stable aerosol. Examples of suitable aerosol formers are glycerine and propylene glycol.

The aerosol-generating substrate preferably comprises homogenised tobacco material, an aerosol-former and water. Providing homogenised tobacco material may improve aerosol generation, the nicotine content and the flavour profile of the aerosol generated during heating of the aerosol-generating article. Specifically, the process of making homogenised tobacco involves grinding tobacco leaf, which more effectively enables the release of nicotine and flavours upon heating.

The invention further relates to a method for performing user authentication in an aerosol-generating device as described herein. The method may comprise the steps of:
initiating a user authentication process by face recognition of the user of the aerosol-generating device by emitting electromagnetic radiation of at least two distinct frequencies by the emitter,
receiving electromagnetic radiation of the least two distinct frequencies by the detector, and
comparing, by means of the controller, the detector output with user data of a user database for user authentication.

The invention further relates to a method for performing user authentication in an aerosol-generating device as described herein. The method comprises the steps of:
initiating a user authentication process by face recognition of the user of the aerosol- generating device by emitting electromagnetic radiation of at least two distinct frequencies by the emitter,
receiving electromagnetic radiation of the least two distinct frequencies by the detector, and
comparing, by means of the controller, the detector output with user data of a user database for user authentication.

The method may further comprise an age verification process comprising comparing, by means of the controller, the detector output with face proportion information indicative of the age of the user from a lookup table for estimating the age of the user.

Below, there is provided a non-exhaustive list of non-limiting examples. Any one or more of the features of these examples may be combined with any one or more features of another example, embodiment, or aspect described herein.

Example ex1. An aerosol-generating device comprising:
an emitter, wherein the emitter is configured to emit electromagnetic radiation of at least two distinct frequencies, wherein one of the frequencies is within the infrared spectrum,
a detector, wherein the detector is configured to receive electromagnetic radiation at least in the spectrum of the two distinct frequencies emitted by the emitter, and
a controller, wherein the controller is configured to perform facial recognition of a user of the aerosol-generating device for user authentication based upon the detector output.

Example ex2. The aerosol-generating device according to example 1, wherein the controller is configured to further perform age verification of a user of the aerosol-generating device based upon the detector output

Example ex3. The aerosol-generating device according to any of the preceding examples, wherein the emitter comprises an LED.

Example ex4. The aerosol-generating device according to any of the preceding examples, wherein the emitter comprises at least two LEDs.

Example ex5. The aerosol-generating device according to any of the preceding examples, wherein the emitter comprises at least one LED capable of emitting electromagnetic radiation in the visible spectrum.

Example ex6. The aerosol-generating device according to any of the preceding examples, wherein the emitter comprises at least one LED capable of emitting electromagnetic radiation in the infrared spectrum.

Example ex7. The aerosol-generating device according to any of the preceding examples, wherein the emitter comprises at least one LED capable of emitting electromagnetic radiation with a wavelength of between 700 nm to 1000 nm, preferably between 820 nm and 890 nm, more preferably of 850 nm.

Example ex8. The aerosol-generating device according to any of the preceding examples, wherein the emitter comprises at least two LEDs, a first LED capable of emitting electromagnetic radiation in the visible spectrum, and a second LED capable of emitting electromagnetic radiation in the infrared spectrum.

Example ex9. The aerosol-generating device according to any of the preceding examples, wherein the emitter comprises an LED ring.

Example ex10. The aerosol-generating device according to any of the preceding examples, wherein the emitter is arranged at a proximal end of the device.

Example ex11. The aerosol-generating device according to any of the preceding examples, wherein the emitter is arranged surrounding a proximal opening of the device.

Example ex12. The aerosol-generating device according to any of the preceding examples, wherein the emitter is arranged to emit the electromagnetic radiation in a proximal direction.

Example ex13. The aerosol-generating device according to any of the preceding examples, wherein the detector is configured as a camera.

Example ex14. The aerosol-generating device according to any of the preceding examples, wherein the detector comprises a focal length of between 10 cm and 30 cm, preferably between 15 cm and 25 cm, more preferably between 18 cm and 22 cm.

Example ex15. The aerosol-generating device according to the preceding example, wherein the controller is configured to control the emitter to emit different colours in the visible spectrum to indicate to a user if the user is within the correct focal length of the detector or not.

Example ex16. The aerosol-generating device according to any of the preceding examples, wherein the controller is configured to prevent aerosol generation of the device, when the facial recognition is negative.

Example ex17. The aerosol-generating device according to any of the preceding examples, wherein the controller is configured to enable aerosol generation of the device, when the facial recognition is positive.

Example ex18. The aerosol-generating device according to any of the preceding examples, wherein the controller comprises a lookup table comprising face proportion information indicative of the age of the user, and wherein the controller is configured to perform age verification by comparing the output of the detector with the information of the lookup table.

Example ex19. The aerosol-generating device according to any of the preceding examples, wherein the device further comprises a user authentication button, wherein the user authentication button is configured to start the user authentication process when pressed.

Example ex20. The aerosol-generating device according to any of the preceding examples, wherein the device comprises a user database, and wherein the controller is configured to compare the output of the detector with the user data of the user database for the user authentication.

Example ex21. Method for performing user authentication in an aerosol- generating device according to any of the preceding examples, wherein the method comprises the steps of:
initiating a user authentication process by face recognition of the user of the aerosol-generating device by emitting electromagnetic radiation of at least two distinct frequencies by the emitter,
receiving electromagnetic radiation of the least two distinct frequencies by the detector, and
comparing, by means of the controller, the detector output with user data of a user database for user authentication.

Example ex22. Method according to the preceding method, wherein the method further comprises an age verification process comprising comparing, by means of the controller, the detector output with face proportion information indicative of the age of the user from a lookup table for estimating the age of the user.

Features described in relation to one embodiment may equally be applied to other embodiments of the invention.

The invention will be further described, by way of example only, with reference to the accompanying drawings in which:

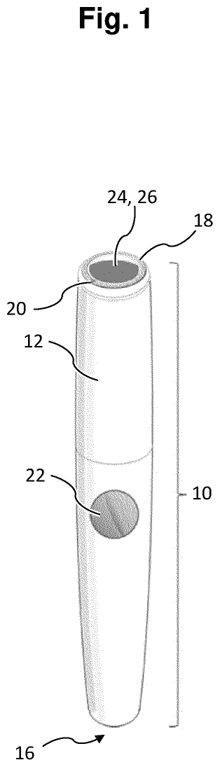

FIG. 1 shows an aerosol-generating device with an emitter and a detector;

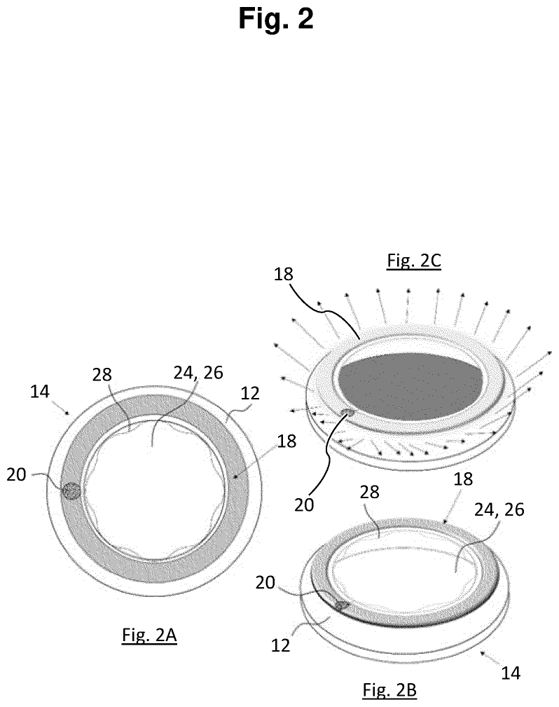

FIGS. 2A-2C shows more detailed views of the emitter and the detector; and

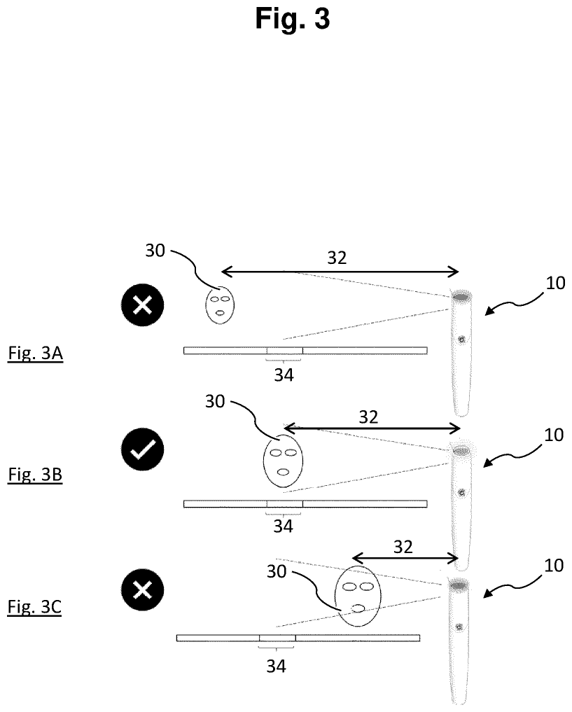

FIGS. 3A-3C shows a user authentication and age verification process utilizing the aerosol-generating device.

FIG. 1 shows an aerosol-generating device 10. The aerosol-generating device 10 comprises a housing 12. The aerosol-generating device 10 comprises a proximal end 14 and a distal end 16. At the proximal end 14 of the aerosol-generating device 10, an emitter 18 and a detector 20 are arranged. Further, FIG. 1 shows a user authentication button 22.

The emitter 18 and the detector 20 are part of a user authentication functionality of the aerosol-generating device 10. Additionally, the emitter 18 and the detector 20 are part of an age verification functionality of the aerosol-generating device 10. To this end, the aerosol-generating device 10 further comprises a controller, which is arranged within the housing 12 of the aerosol-generating device 10 and not shown in FIG. 1.

The emitter 18 is configured as a ring-shaped LED. The emitter 18 is arranged surrounding an opening 24 of the aerosol-generating device 10. The opening 24 enables an aerosol-generating article to be received in a cavity 26 of the aerosol-generating device 10. In other words, the opening 24 arranged at the proximal end 14 of the aerosol-generating device 10 is an opening 24 of the cavity 26 of the aerosol-generating device 10 for receiving an aerosol-generating article comprising aerosol-forming substrate.

The aerosol-generating device 10 as shown in FIG. 1 is configured to perform a user verification functionality and an age verification functionality as described in the following with reference to FIGS. 2 and 3.

FIGS. 2A to 2C show a more detailed view of the proximal end 14 of the aerosol-generating device 10.

FIG. 2A shows a top view of the proximal end 14 of the aerosol-generating device 10. The emitter 18 is shown as a ring-shaped LED surrounding the cavity 26 of the aerosol- generating device 10. Protrusions 28 are provided to the center of the aerosol-generating article, when the aerosol-generating article is inserted into the cavity 26. The gaps between the individual protrusions 28 further allow airflow.

The detector 20 is provided as a camera. The detector 20 is arranged next to the opening 24 at the emitter 18. The detector 20 is configured to receive electromagnetic radiation of the wavelengths emitted by the emitter 18.

The emitter 18 is configured to emit electromagnetic radiation of at least two distinct wavelengths. FIG. 2B shows a slightly different view of the proximal end 14 of the aerosol-generating device 10, while FIG. 2C shows the emitter 18 in operation emitting electromagnetic radiation.

To perform of the user authentication functionality, a user presses the user authentication button 22. Subsequently, a user aligns the emitter 18 and the detector 20 at the proximal end 14 of the aerosol-generating device 10 such that the emitter 18 illuminates the face of the user. At the same time, the detector 20 gathers image data of the user's face.

This process is indicated in FIG. 3. FIG. 3 further shows that the distance between the detector 20 and the face of the user, i.e. the focal distance of the detector 20, should be within a certain range to enable the age verification functionality.

For the user authentication functionality, the image data of the detector 20, comprising information about a user's face, is processed by the controller of the aerosol-generating device 10. The image data of the detector 20 is compared with preset face information stored in a lookup table. The preset face information comprises user information, namely which user is authorized to use the aerosol-generating device 10. If the controller determines a match between the image data of the detector 20 and the preset face information, the user authentication is positive. During initial activation of the device, the user may input the preset face information, for example by taking multiple pictures of his or her face using the detector 20. This information could be used as base 30 information for the user authentication functionality.

For the age verification functionality, the focal length 32 of the detector 20 is utilized. The user's face has to be within the optimal focal length 34 of the detector 20. In this case, the processor can determine information such as the axial eye length central region human length of the user. This information can only be determined reliably, if the user is in the optimal focal length 34 of the detector 20. This information can be compared with the preset face information comprising one or both of axial eye length distributions and central region human length distributions. In this way, the controller can estimate an age of the user. If the user is to be estimated to be an adult, the age verification is positive. If the user is to be estimated to be a teenager and particularly if the user is to be estimated to be a child, the age verification is negative.

If one or both of the user authentication and the age verification is negative, the controller prevents the aerosol-generating device 10 from generating an aerosol.

FIG. 3A shows the user having his or her face too far away from the detector 20. FIG. 3B shows the user having his or her face in the optimal focal length 34 of around 18 cm to 22 cm distanced from the detector 20. FIG. 2C shows the user placing his or her face too close to the detector 20. In the optimal focal length 34, the detector 20 can, together with the controller, determine the base 30 proportions of the user and thus estimate the age of the user.

The colour of the electromagnetic radiation emitted by the emitter 18 can be used to guide a user through the user authentication and the age verification. For example, if the user presses the user authentication button 22, the emitter 18 may emit a first colour to signal that the aerosol-generating device 10 is ready to perform the user authentication and the age verification. The user may then that place his or her face before the detector 20. If the user has placed his or her face within the optimal focal length 34 of the detector 20, the emitter 18 may emit a second colour distinct from the first colour to indicate to a user that the user authentication and the age verification may now commence. During the time the user authentication and the age verification commences, a further distinct colour may be used by the emitter 18 to indicate to a user the ongoing processes. The end of the user authentication and the age verification may be indicated by the emitter 18 with a further colour.

The emitter 18 is configured to emit electromagnetic radiation in the visible spectrum and separately and at the same time emit electromagnetic radiation in the infrared spectrum. This means that the user authentication and age verification can be performed during daytime and also at low light conditions.

1-15. (canceled)

16. An aerosol-generating device, comprising:
an emitter configured to emit electromagnetic radiation of at least two distinct frequencies, wherein one of the at least two distinct frequencies is within the infrared spectrum and another one of the at least two distinct frequencies is within the visible light spectrum;
a detector configured to receive electromagnetic radiation at least in the spectrum of the at least two distinct frequencies emitted by the emitter; and
a controller configured to perform facial recognition of a user of the aerosol-generating device for user authentication based upon detector output.

17. The aerosol-generating device according to claim 16, wherein the controller is further configured to further perform age verification of the user of the aerosol-generating device based upon the detector output.

18. The aerosol-generating device according to claim 16, wherein the emitter comprises at least one LED configured to emit electromagnetic radiation with a wavelength of between 700 nm and 1,000 nm.

19. The aerosol-generating device according to claim 16, wherein the emitter comprises at least one LED configured to emit electromagnetic radiation with a wavelength of 850 nm.

20. The aerosol-generating device according to claim 16, wherein the emitter comprises an LED ring.

21. The aerosol-generating device according to claim 16, wherein the emitter is arranged surrounding a proximal opening of the aerosol-generating device.

22. The aerosol-generating device according to claim 16, wherein the emitter is arranged to emit the electromagnetic radiation in a proximal direction.

23. The aerosol-generating device according to claim 16, wherein the detector is further configured as a camera.

24. The aerosol-generating device according to claim 16, wherein the detector comprises a focal length of between 10 cm and 30 cm.

25. The aerosol-generating device according to claim 16, wherein the detector comprises a focal length of between 18 cm and 22 cm.

26. The aerosol-generating device according to claim 24, wherein the controller is further configured to control the emitter to emit different colours in the visible spectrum to indicate to the user if the user is within a correct focal length of the detector or not.

27. The aerosol-generating device according to claim 16, wherein the controller is further configured to prevent aerosol generation of the aerosol-generating device when the facial recognition is negative.

28. The aerosol-generating device according to claim 16,
wherein the controller comprises a lookup table comprising face proportion information indicative of an age of the user, and
wherein the controller is further configured to perform age verification by comparing an output of the detector with information of the lookup table.

29. The aerosol-generating device according to claim 16,
wherein the aerosol-generating device further comprises a user authentication button, and
wherein the user authentication button is configured to start a user authentication process when pressed.

30. The aerosol-generating device according to claim 16,
further comprising a user database,
wherein the controller is further configured to compare an output of the detector with user data of the user database for the user authentication.

31. A method for performing user authentication in an aerosol-generating device according to claim 16, the method comprising the steps of:
initiating a user authentication process by face recognition of a user of the aerosol- generating device by emitting electromagnetic radiation of at least two distinct frequencies by the emitter, wherein one of the at least two distinct frequencies is within the infrared spectrum and one of the at least two distinct frequencies is within the visible light spectrum;
receiving electromagnetic radiation of the least two distinct frequencies by the detector; and
comparing, by means of the controller, detector output with user data of a user database for user authentication.

32. The method according to claim 31, further comprising an age verification process comprising comparing, by means of the controller, the detector output with face proportion information indicative of an age of the user from a lookup table for estimating the age of the user.
